(19) United States
(12) Patent Application Publication
(10) Pub. No.: US 2006/0066440 A1
(43) Pub. Date: Mar. 30, 2006

(54) Structure of door lock control apparatus

(76) Inventor: Ming-Hsiang Yeh, Taipei City (TW)

Correspondence Address: TROXELL LAW OFFICE PLLC;SUITE 1404, 5205 LEESBURG PIKE, FALLS CHURCH, VA, 22041, US

(21) Appl. No.: 10/950,535

(22) Filed: Sep. 28, 2004

(51) Int. Cl. H04Q 1/00; G05B 19/00

(52) U.S. Cl. 340/5.61; 340/5.53

(57) ABSTRACT

An improved structure of a door lock control apparatus is disclosed. The present invention mainly comprises: a control box and a monitor, wherein a plurality of function keys, a microphone, a speaker, a camera lens, an identifier, a storage device, two grips, a tongue part, and a latch part are mounted on the outside of the control box, and a central processing unit and a wireless transmitter are mounted on the inside of the control box, wherein two keyholes are mounted respectively on the two grips, the tongue part is moved by the two grips in an interactive way, the latch part is controlled by the keyhole, the lock body is coupled with an entrance door, and the operation for opening and closing the latch part is further controlled by identification of the identifier and the camera lens on the control box so as to achieve the purpose of entrance control.

### BACKGROUND OF THE INVENTION

The present invention relates to an improved structure of a door lock control apparatus with the function of integration, and more particularly to an apparatus that is suitable for offices, residence houses or places like that.

In order to recognize the incoming person, the most common way is to utilize intercoms besides the setting of management departments or entrance-guarding machines on the existed buildings or residence houses. Newly built communities can recognize the incoming person through intercoms that have video function before opening the door. However, aged communities or offices do not equip with this device. Therefore, after communication is performed via the intercom, the incoming person will not be recognized through a peephole, or a safety chain, or an opened inner door of two iron doors set on the entrance until he reaches the entrance.

In the aforementioned way, however, it is always not able to clearly recognize the incoming person if there is artificial carelessness or somebody intend to avoid it. A security dead place, which is a major drawback of the conventional way, is therefore formed. Whereas the aforementioned drawbacks of the conventional structure, the present inventor has been made diligent studies with a quiet mind to develop and assemble an improved structure of a door lock control apparatus that can maintain safety and increase life enjoyment for providing this apparatus for consumers.

### SUMMARY OF THE INVENTION

The main purpose of the present invention is to provide an improved structure of a door lock control apparatus for ensuring security and increasing life enjoyment.

Another purpose of the present invention is to provide an improved structure of a door lock control apparatus for leaving voice message.

Still another purpose of the present invention to provide an improved structure of a door lock control apparatus that is capable of automatically recording incoming and outgoing time and images of persons.

According to the aforementioned purposes of the present invention, an improved structure of a door lock control apparatus is provided. The present invention mainly comprises: a control box and a monitor, wherein a plurality of function keys, a microphone, a speaker, a camera lens, an identifier, a storage device, two grips, a tongue part, and a latch part are mounted on the outside of the control box, and a central processing unit and a wireless transmitter are mounted on the inside of the control box, wherein two keyholes are mounted respectively on the two grips, the tongue part is moved by the two grips in an interactive way, the latch part is controlled by the keyhole, the lock body is coupled with an entrance door, and the operation for opening and closing the latch part is further controlled by identification of the identifier and the camera lens on the control box so as to achieve the purpose of entrance control.

The other features and preferred embodiments of the present invention will now be described with reference to the accompanying drawings.

### BRIEF DESCRIPTION OF THE DRAWINGS

FIG. 1 is a perspective view showing an outward-appearance of a preferred embodiment in accordance with the present invention.

FIG. 2 is a circuit diagram of a preferred embodiment in accordance with the present invention.

FIG. 3 is a schematic diagram showing usage of a preferred embodiment of the present invention.

FIG. 4 is a perspective view showing second preferred embodiment in accordance with the present invention.

FIG. 5 is a perspective view in another direction, which shows the second preferred embodiment in accordance with the present invention.

FIG. 6 is a schematic diagram showing usage of the second preferred embodiment of the present invention.

### DETAILED DESCRIPTION OF THE PREFERRED EMBODIMENT

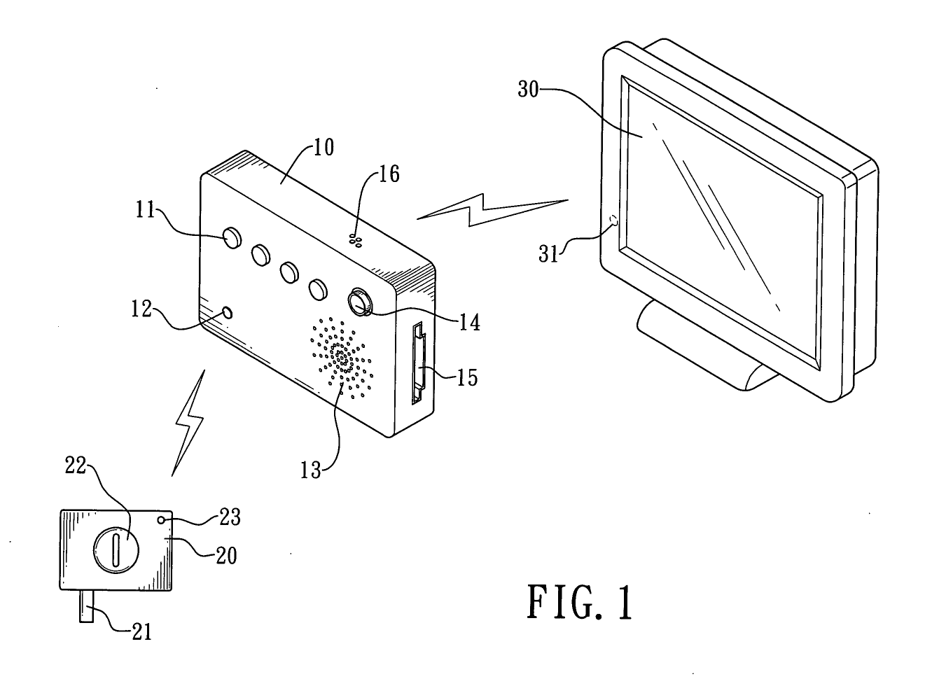

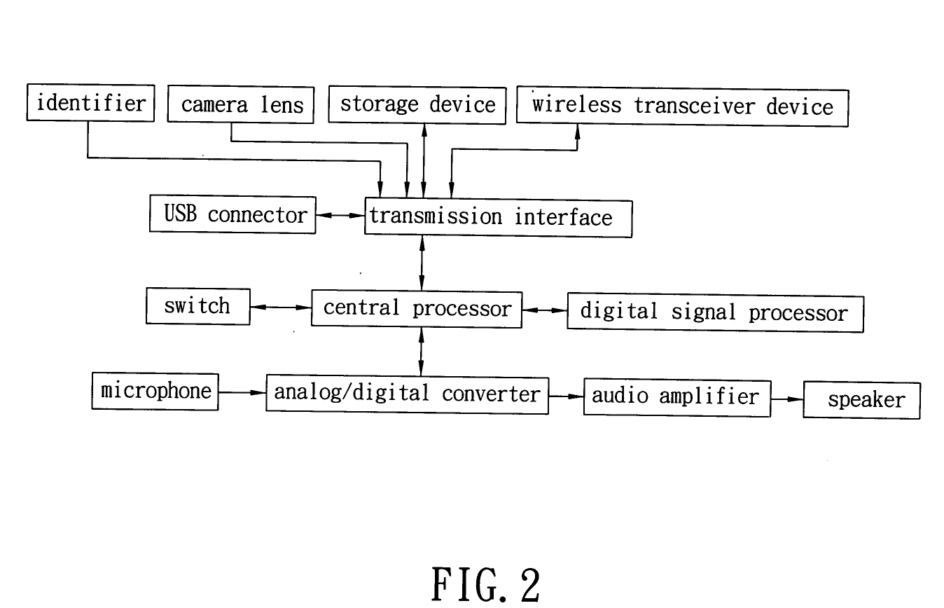

Referring to FIG. 1 and FIG. 2, the present invention mainly comprises a control box 10, a lock body 20, and a monitor 30. A plurality of function keys 11, an identifier 12, a speaker 13, a camera lens 14, a storage device 15, and a microphone 16 are mounted on the control box 10. A central processing unit (CPU) is mounted inside the control box 10. In addition, the CPU is further connected to an analog/digital converter, a digital signal processor, an audio amplifier, an output interface, and a wireless transmitter.

On the outside of the lock body 20, a keyhole 22 and a latch part 21 are mounted. The keyhole 22 controls the latch part 21, which is connected to a reed switch, directly. In addition, a receiver 23 controls the reed switch.

A wireless receiver 31 is mounted on the monitor 30 for receiving and showing images captured by the camera lens 14 of the control box 10.

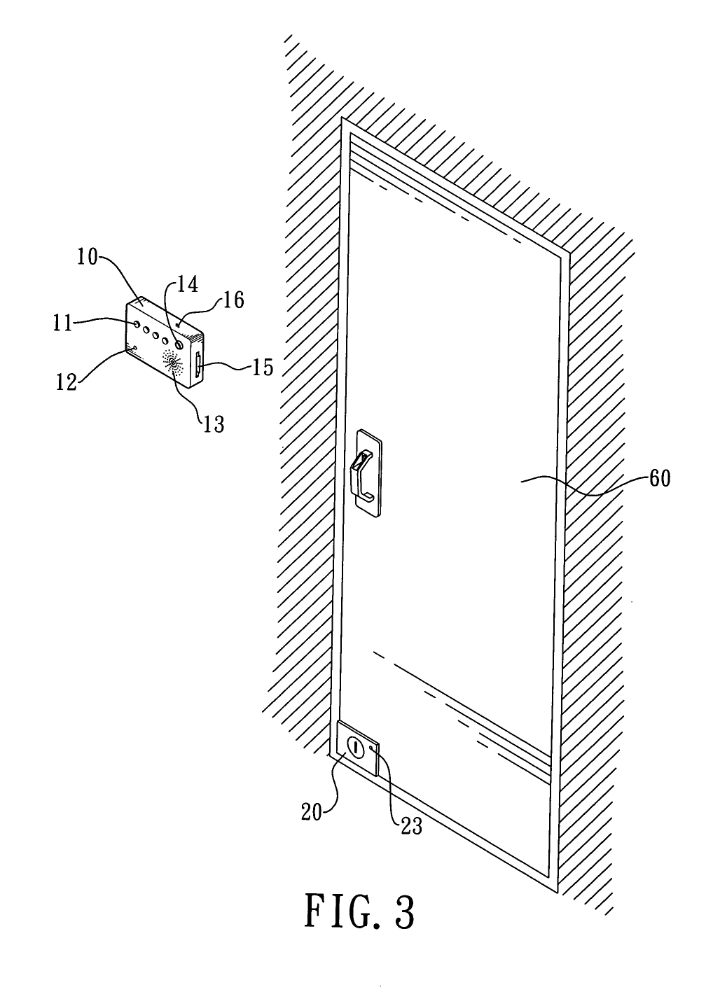

Referring to FIG. 3, the control box 10 can be mounted on a proper position of the sidewall near a door plank 60, or coupled with a proper position of the door plank 60 near a central part thereof. Moreover, the lock body 20 is mounted on the bottom of the door plank 60 such that the operation for opening or closing the door plank 60 is controlled by the latch part 21 of the lock body 20. The monitor 30 is positioned on an indoor position, which is readily observable. In this preferred embodiment, the identifier 12 is configured to be a RFID (Radio Frequency IDentification) system. In a common condition, the latch part 21 is in an extended form such that the door plank 60 is closed. When a person having an entrance card wants to pass the entrance guard, then the identifier 12 will access the entrance card. If data are verified, then the wireless transmitter of the control box 10 sends out a control instruction. When the receiver 23 of the lock body 20 receives this control instruction sent from the control box 10, the reed switch will be actuated so as to force the latch part 21 to move inwardly such that the door plank 60 is opened for admitting this person to get in and out.

If there is a visitor having no entrance card, then he can press the function keys 11 on the control box 10 to notify the counter staff that there is a visitor. At the same time, the camera lens 14 on the control box 10 captures the appearance of this visitor, which is then transmitted through the wireless transmitter. When the wireless receiver 31 on the monitor 30 receives data, the counter staff is capable of clearly watching the visitor through the monitor 30 and opening the door plank 60 by using an opening key. In addition, the control box 10 can record images and incoming/outgoing time of this person automatically when he passes through the door. Therefore, one hundred percent effect on the entrance guard can be accomplished.

Furthermore, a message can be left for a predetermined person, or different music may be broadcasted through the microphone 16 when he passes through the door by using the control box 10 thereby producing various automatic functions for upgrading life enjoyment.

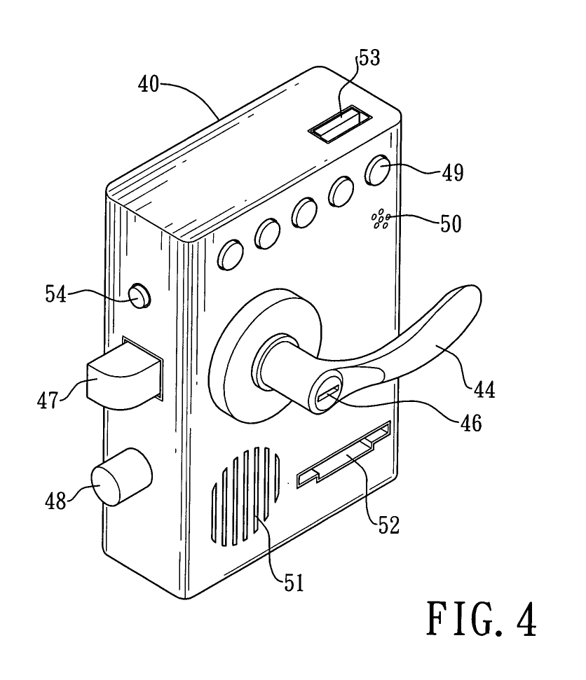

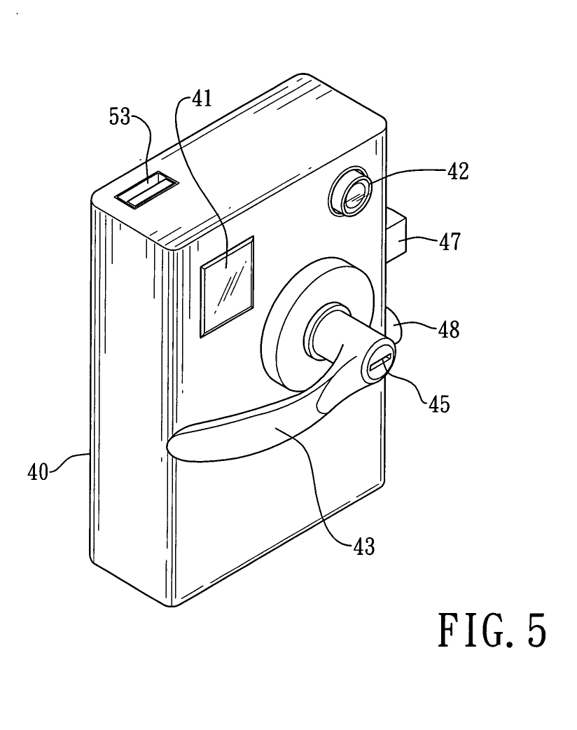

Referring to both FIG. 4 and FIG. 5, the second preferred embodiment of the present invention that comprises a control box 40 and a monitor 30 is shown. A grip 44 and a grip 43 having a keyhole 46 and a keyhole 45 respectively are pivotally mounted on the front and rear surfaces of the control box 40 respectively. In addition, a microphone 50, a speaker 51, a storage device 52, and a plurality of function keys 49 are mounted on the surface of the grip 44 on the control box 40. A camera lens 42 and an identifier 41 are mounted on the surface of the grip 43 on the control box 40. A tongue part 47, a latch part 48, and a sensor 54 are moveably mounted on a side surface of the control box 40. The latch part 48 is also connected to a reed switch. An output/input device 53 is mounted on the top of the control box 40.

A CPU, an analog/digital converter, an audio amplifier, a digital signal processor, an output interface, and a wireless transmitter are mounted inside the control box 40. The tongue part 47 of the control box 40 is moved by the grip 44 and the grip 43 in an interactive way. The latch part 48 controlled by the keyholes 46 and 45.

A wireless receiver 31 is mounted on the monitor 30 for receiving and showing images captured by the camera lens 42 on the control box 40.

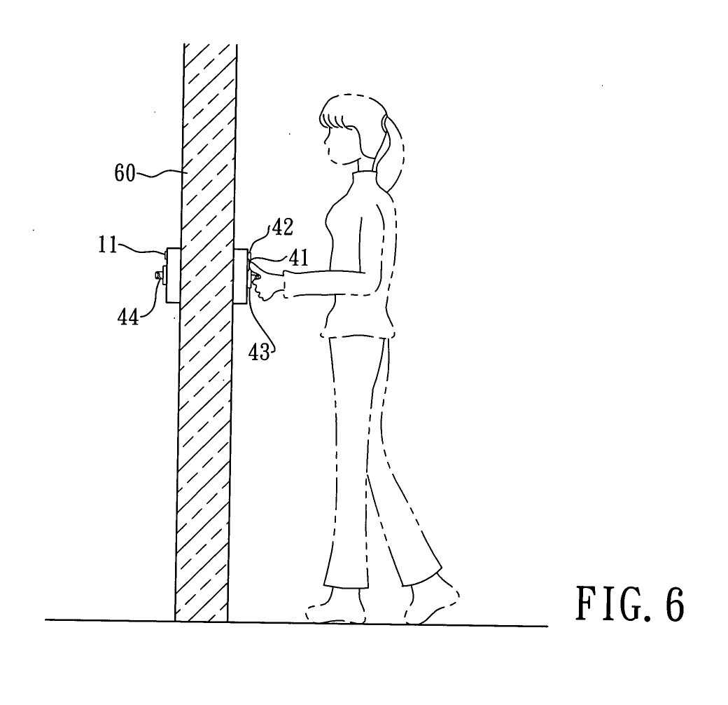

As shown in FIG. 6, the control box 40 having the camera lens 42 and the identifier 41 faced outwardly is mounted on a door plank of a residence house that has less incoming and outgoing members. In this preferred embodiment, the identifier 41 is configured to be a fingerprint identifier, wherein the fingerprint data of the whole family are inputted in the control box 40. Thus, when a family member goes home, then he just needs to put his finger on the identifier 41 for enabling the control box 40 to identify his fingerprint. If the data are correct, the reed switch will be actuated so as to force the latch part 48 to move inwardly for opening the door plank. The camera lens 42 on the control box 40 is able to transmit the visitor's image to the monitor 30 to recognize a visitor in a wireless way while this visitor is there.

Furthermore, a voice message can be recorded in the control box 40 through the microphone 50. After recognition by the identifier 41, the control box 40 will know that a target person is home. When the door plank is opened, the sensor 54 is triggered at the same time. Therefore, the recorded voice message will be shown for the target person. In addition, the camera lens 42 can be configured to be controlled by the sensor 54.

It is apparent that the apparatus of the present invention comprises the following advantages:

1. It is possible to record image and incoming/outgoing time of a person automatically when this person passes through the door such that one hundred percent effect on the entrance guard can be accomplished.

2. When the identification data of the person are correct, then he does not need to touch the door plank such that the communication of diseases is diminished and sanitation is maintained effectively.

3. With the identification of the identifier, it is able to come in and go out freely without carrying keys.

4. In addition to the function of leaving voice message, a predetermined voice message can be shown for a target person to upgrading life enjoyment by using the identification of the identifier.

However, the above description merely illustrates the preferred embodiments of the present invention, and the applicable scope of the present invention is not limited hereto. Any obvious modification and revision made by a person skilled in the art are included within the spirit and scope of the present invention.

To sum up, the present invention is able to achieve the expected purpose of the present invention for integrating with several common structures carried by people nowadays to provide with an improved structure of a door lock control apparatus. The application that complies with utility is therefore submitted for a patent.

What the invention claimed is:

1. An improved structure of a door lock control apparatus comprising:
a control box having a plurality of function keys, a microphone, a speaker, a camera lens, an identifier, and a storage device mounted on the outside thereof, and a central processing unit and a wireless transmitter mounted on the inside thereof;
a monitor having a wireless receiver; and
a lock body having a keyhole, a wireless receiver, and a latch part that is controlled by the keyhole and the wireless receiver, wherein the lock body is coupled with an entrance door, the operation for opening and closing the latch part of the lock body is further controlled by identification of the identifier and the camera lens on the control box so as to achieve the purpose of entrance control.

2. The improved structure of the door lock control apparatus of claim 1, wherein the identifier is a Radio Frequency IDentification (RFID) System.

3. The improved structure of the door lock control apparatus of claim 1, wherein a voice message is left to a predetermined person by using the control box through the microphone, and the voice message is showed when the identifier verifies the predetermined person.

4. The improved structure of the door lock control apparatus of claim 1, wherein the identifier is a Radio Frequency IDentification (RFID) System and a voice message is left to a predetermined person by using the control box through the microphone, and the voice message is showed when the identifier verifies the predetermined person.

5. The improved structure of the door lock control apparatus of claim 1, wherein the storage device is a slot for receiving a memory card.

6. The improved structure of the door lock control apparatus of claim 1, wherein the storage device is a USB connector for receiving a portable hard disk.

7. The improved structure of the door lock control apparatus of claim 1, wherein the identifier is a fingerprint identifier.

8. The improved structure of the door lock control apparatus of claim 1, wherein the identifier is a pupil identifier.

9. An improved structure of a door lock control apparatus comprising:
a control box having a plurality of function keys, a microphone, a speaker, a camera lens, an identifier, two grips, a tongue part, and a latch part mounted on the outside thereof, and a central processing unit and a wireless transmitter mounted on the inside thereof; and
a monitor, wherein
two keyholes are mounted respectively on the two grips, the tongue part is moved by the two grips in an interactive way, the latch part is controlled by the keyhole, the lock body is coupled with an entrance door, and the operation for opening and closing the latch part is further controlled by identification of the identifier and the camera lens on the control box so as to achieve the purpose of entrance control.

10. The improved structure of the door lock control apparatus of claim 9, wherein the camera lens and the identifier are mounted on the outside of a door plank, and the plurality of function keys, the microphone, the speaker, and the storage device are mounted on an inner lateral of the door plank.

11. The improved structure of the door lock control apparatus of claim 9, wherein the identifier is a Radio Frequency IDentification (RFID) System.

12. The improved structure of the door lock control apparatus of claim 9, wherein a voice message is left to a predetermined person by using the control box through the microphone, and the voice message is showed when the identifier verifies the predetermined person.

13. The improved structure of the door lock control apparatus of claim 9, wherein the identifier is a Radio Frequency IDentification (RFID) System and a voice message is left to a predetermined person by using the control box through the microphone, and the voice message is showed when the identifier verifies the predetermined person.

14. The improved structure of the door lock control apparatus of claim 9, wherein the storage device is a slot for receiving a memory card.

15. The improved structure of the door lock control apparatus of claim 9, wherein the storage device is a USB connector for receiving a portable hard disk.

16. The improved structure of the door lock control apparatus of claim 9, wherein the identifier is a fingerprint identifier.

17. The improved structure of the door lock control apparatus of claim 9, wherein the identifier is a pupil identifier.
